(19) United States
(12) Patent Application Publication
(10) Pub. No.: US 2012/0030016 A1
(43) Pub. Date: Feb. 2, 2012

(54) METHOD AND SYSTEM FOR DISTRIBUTING REVENUE AMONG USER-AUTHORS

(76) Inventor: Jeffrey T. Arnold, Atlanta, GA (US)

(21) Appl. No.: 13/187,926

(22) Filed: Jul. 21, 2011

Related U.S. Application Data
(63) Continuation of application No. 11/585,636, filed on Oct. 24, 2006, now abandoned.
(60) Provisional application No. 60/730,202, filed on Oct. 25, 2005.
(60) Provisional application No. 60/846,483, filed on Sep. 22, 2006.

(51) Int. Cl. G06Q 30/00

(52) U.S. Cl. 705/14.49; 705/14.69

(57) ABSTRACT

Described is a method and system for receiving user-authored content from one or more user-authors, receiving at least one advertisement from one or more third-parties, associating the at least one advertisement with the user-authored content and determining a compensation for at least one of the user-authors, wherein the compensation is based on at least one of the number of advertisements associated with the user authored content and a number of associations made with the user-authored content by third parties.

### PRIORITY CLAIM/INCORPORATION BY REFERENCE

The present application claims priority to U.S. Provisional Patent Application No. 60/730,202 entitled “APPARATUS, SYSTEM AND METHOD FOR THE DISTRIBUTION OF REVENUE AMONG USER AUTHORS ON A NETWORK” filed on Oct. 25, 2005, the specification of which is expressly incorporated, in its entirety, herein. In addition, the present application also claims priority to U.S. Provisional Patent Application No. 60/846,483 entitled “METHOD AND SYSTEM FOR DISTRIBUTING REVENUE AMONG USER-AUTHORS” filed on Sep. 22, 2006, the specification of which is expressly incorporated, in its entirety, herein.

### BACKGROUND

Electronic marketing or “e-marketing” is a type of marketing that operates through various means of electronic communications. E-marketing may be used in conjunction with digital technologies such as Internet browsers, e-mail servers, online databases, digital television service, and web-enabled mobile phone service. Furthermore, a business may utilize an advertisement server for placing or embedding advertisements from various businesses onto or within the content displayed over a website in order to sell, promote, introduce, providing savings products and services. In exchange for advertising services, the ad server may collect revenue from the advertising businesses according to a variety of payment options.

A problem with online advertisement serving is that the ad server is unable to accurately project the amount of traffic the content of a website may generate. Typically, the ad server will attempt to project the cost and worth of an e-marketing campaign. This projection by the ad servers may use cost per thousands (or mille) (“CPM”) approximations to estimate the amount of web traffic to the advertising business. For example, a website that has a CPM rate of $10 and guarantees advertisers 500,000 viewers will charge $10,000 ($10×500) for an advertising business to place an ad (e.g., a banner ad, a sidebar ad, a hyperlink, etc.) within the content of the website. Based on the CPM approximations, an ad server will have to guarantee a certain number of viewer visits and/or downloads to the websites containing the ad. It is difficult to accurately project how much traffic the content on a website may generate.

A further problem is providing authors with incentive to contribute the content to websites featuring the advertisements. While revenue is generated from the advertising businesses and any subscription fees required from viewers, the ad server using CPM approximations are not able to promptly and accurately determine a compensation for any content provider. Thus, payments based on CPM approximations may limit any encouragement to the content providers.

### SUMMARY OF THE INVENTION

A method for receiving user-authored content from one or more user-authors over a network, receiving at least one advertisement from one or more third-parties over the network, placing the at least one advertisement within the user-authored content, monitoring activities of one or more content viewers over the network and determining a compensation for at least one of the user-authors, wherein the compensation is based on the monitored activities of the one or more content viewers.

A system having a first receiving means receiving user-authored content from one or more user-authors over a network, a second receiving means receiving at least one advertisement from one or more third-parties over the network, a placement means placing the at least one advertisement within the user-authored content, a monitoring means monitoring activities of one or more content viewers over the network and a determining means determining a compensation for at least one of the user-authors, wherein the compensation is based on the monitored activities of the one or more content viewers.

A system having an application server for receiving user-authored content from one or more user-authors, and for receiving at least one advertisement from one or more third-parties, wherein the application server places the at least one advertisement within the user-authored content, a content database for storing the user-authored content, wherein the content database is accessible to a viewer over a network and a advertisement database for storing the advertisement. The system further implements a first algorithm for measuring at least one of the number of times the user-authored content is accessed by the viewer and the number of links to the user-authored content and a second algorithm for calculating the amount of revenue generated by the network to share with the user-author.

A method for receiving user-authored content from one or more user-authors, receiving at least one advertisement from one or more third-parties, associating the at least one advertisement with the user-authored content and determining a compensation for at least one of the user-authors, wherein the compensation is based on at least one of the number of advertisements associated with the user authored content and a number of associations made with the user-authored content by third parties.

### BRIEF DESCRIPTION OF THE DRAWINGS

FIG. 1 shows an exemplary system for publishing and distributing content over a network for sharing revenue derived from the content according to the present invention.

FIG. 2 shows an exemplary method for publishing and distributing content over a network for the sharing of revenue derived from the content according to the present invention.

FIG. 3 shows an exemplary display of the published article of user-authored content as presented to the content viewer over the network according to the present invention.

### DETAILED DESCRIPTION

The present invention may be further understood with reference to the following description of exemplary embodiments and the related appended drawings, wherein like elements are provided with the same reference numerals. The present invention is related to systems and methods used for allocating revenue derived from a network or system that publishes and distributes user-authored content. Specifically, the present invention is related to systems and methods for distributing revenue derived from a network that publishes and distributes user-authored content, wherein the distribution to the user-author is based on a predetermined formula. Thus, the present invention may provide users of an exemplary network with incentives in order to encourage the generation, publication, and distribution of user-authored content throughout the network.

According to exemplary embodiments, the present invention may be operable within a variety of network architectures and/or network architecture combinations. The term network may apply to all currently existing and future developed architectures. These network architectures may include local area networks (“LANs”), either wired or wireless. Exemplary LANs include peer-to-peer (“P2P”) networks, virtual private networks (“VPNs”), and client-server networks. Alternatively, the network architectures may include wide area networks (“WANs”), either wired or wireless. Regardless of the type of network architecture, or combination of architectures, used for the exemplary embodiments of the present invention, content may be generated by user-authors and made available to viewers over the network.

According to the exemplary embodiments of the present invention, the content available over the network may be user-authored content. The term user-author content may be defined as any content created by a subscriber, member, and/or user to the exemplary network of the present invention, wherein an article of user-authored content may be of any type, such as, for example, a written commentary, an editorial, a musical composition, a novel, an essay, a product review, a help guide (e.g., instructional information), educational material, medical information, a fine art composition, multimedia work, audiovisual work, and/or a movie. Furthermore, the various user-authored content may be placed in an exemplary format for publication and distribution throughout the network. The exemplary format may digitize the user-authored content, thereby placing the content in a standardized digital format. Once placed in the exemplary format, the user-authored content may then be made available to other users (e.g., consumers) of the network.

A common architecture, but not the exclusive architecture, for which the present invention may be useful is in the context of a publicly available website. For example, the owner of the website may have a web server (or a series of web servers) that includes various content. A source of revenue for the owner is through the sale of advertising space within the content. However, the cost associated with generating new and topical content (e.g., by having a staff of in-house writers) may not be commercially viable because the cost is too great or the desired quantity of content is so large that it would take too long to generate the content. Without the large amount of content, the website may not receive a sufficient amount of traffic in order to justify the advertising rates that it will take to make the website a commercially viable operation. Alternatively, the website may contain a mix of user authored content and non-user authored content, such as professionally authored contented. The percentage of one type of content to another may range anywhere between a very small percentage to 100%.

As described above, a solution is to have user authors contribute content to the website so that a desired amount of content is available. However, the user authors must be incentivized in some manner to contribute this content. The exemplary embodiments of the present invention provide a system and method for providing such incentives to user authors. Those skilled in the art will understand that the above example of a publicly available website is only exemplary and that the present invention may also be applied to any type of content providing system.

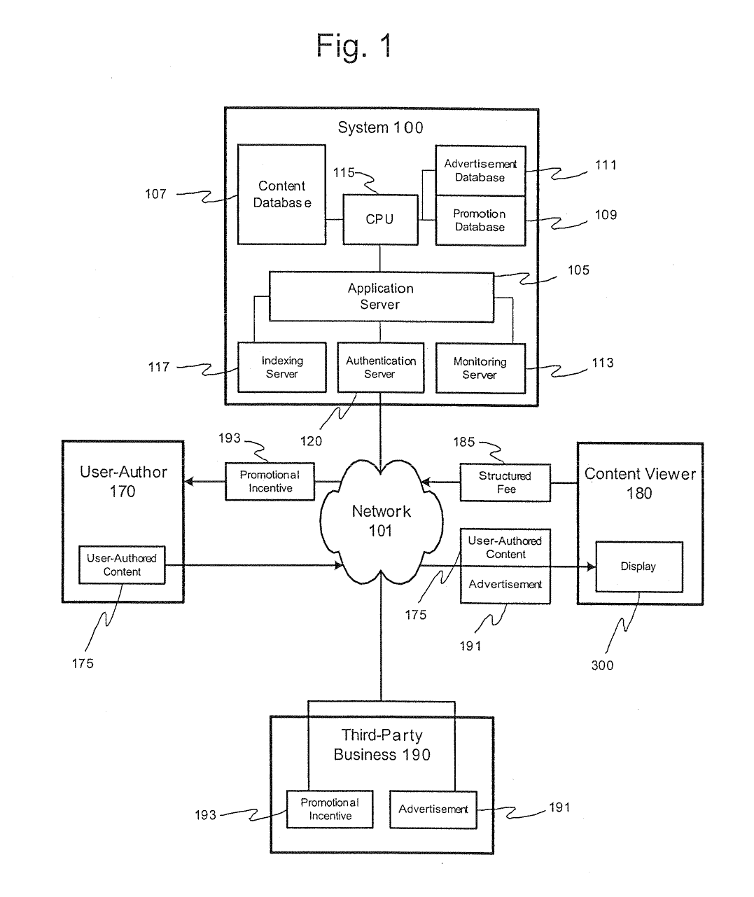

FIG. 1 shows an exemplary system 100 for publishing and distributing content over a network for sharing revenue derived from the content according to the present invention. The exemplary system 100 may operate over an exemplary network 101, e.g., the Internet, in order to interact with at least one user-author 170, at least one content viewer 180, and at least one third-party business partner 190. The exemplary system 100 may include an application server 105, a content database 107, a promotion database 109, an advertisement database 111, a monitoring server 113, and a central processing unit (“CPU”) 115 for providing control data throughout the system 100. Furthermore, the exemplary system 100 may also include an authentication server 120 in order to verify the access to the system 100 for the user-author 170, the content viewer 180, and/or the third-party business partner 190. Those skilled in the art will understand that components included within the system 100 are only exemplary and that the present invention may be applied to any type of arrangements configured on a variety of network architectures.

According to an exemplary embodiment of the present invention, the at least one user-author 170 may be in communication with the exemplary system 100 via the network 101. Optionally, the user-author 170 may be requested to log onto the system 100 via the authentication server 120. The authentication server 120 may require the user-author 170 to register with the exemplary system 100, wherein the registration may request personal information regarding the user-author for verification purposes. Once verified, if needed, the user-author 170 may generate one or more articles of user-authored content 175 and transmit the content 175 to the exemplary system 100 in order to be uploaded and stored onto the content database 107. Furthermore, the user-author 170 may be a member of a particular organization or professional affiliation, wherein access to the network 101 may be limited to members of the organization or professional affiliation. Those skilled in the art will understand that access to the system 100 by the user author 170, content viewer 180 and/or the third party business 190 may be restricted or controlled in a variety of manners and that the authentication server 120 may be used to control such access.

Furthermore, the content viewer 180 may be in communication with the exemplary system 100 via the network 101. Similar to the optional verification of the user-author 170, the content viewer 180 may be requested to provide personal information and/or payment information to the authentication server 120. The content viewer 180 may be a member of a particular organization or professional affiliation. Alternatively, the system 100 may operate on a subscription basis, wherein content viewers pay a structured fee 185 in order to access user-authored content 175 over the network 101. The structured fee 185 may be a daily, weekly, monthly, or annual subscription fee payable by the content viewer 180 or by the organization of the content viewer 180. Alternatively, the structured fee 185 may be a predetermined payment based on the number of viewings or downloads of the user-authored content 175. The amount of the structured fee 185 may vary from content to content based on the respective subject matters of the user-authored contents.

In addition, at least one third-party business partner 190 may be in communication with the exemplary system 100 via the network 101. The third-party business partner 190 may supply advertisements 191 and/or promotional incentives 193 to the exemplary system 100 to be stored within the promotion database 109 and advertisement database 111, respectively. The application server 105 may use placement algorithms to place selected advertisements 191 of the third-party business partner 190 within the selected articles of user-authored content 175. For example, the advertisements 191 placed within the articles of user-authored content 175 may be an embedded “banner ad” or “sidebar ad” within a web page displaying the user-authored content 175 over the Internet. Banner ads and sidebar ads may be described as a web-based advertising means for a business to attract web traffic from viewers to a specific website of the advertising business. Exemplary banner/sidebar ads may be in the form of static images as well as multimedia objects using animation and/or sound. Alternatively, the advertisement 191 may simply be a hyperlink directing the content viewer 180 to a specific address on the Internet.

Once the banner ad, sidebar ad, hyperlink, or any alternative form of advertising, is embedded within, or placed adjacent to, the articles of user-authored content 175 on the network 101, the ad may be viewed and “clicked-through” by the content viewer 180. A click-through may be described as the process of directing a viewer to an intended web address upon receiving instructions from a viewer's pointing device, e.g., mouse pointer, stylus, touch screen, etc. The monitoring server 113 may track the number of times the advertisement 191 is displayed, the number of times a viewer clicks-through the advertisement 191, the number of times a sale by the third-party business partner 190 is the result of a click-through, etc. The functions of the monitoring server will be described in greater detail below. Furthermore, exemplary embodiments of the system 100 may utilize a predetermined schedule to determine which of the advertisements 191 from the advertisement database 111 will be placed within or adjacent to selected articles of user-authored content 175.

Also contemplated within the disclosure of the present invention is a system and method for the distribution of promotional incentives 193 along with allocation of revenue to the user-authors of the network 101. The promotional incentives 193 may include pre-purchased promotional coupons or codes, gift certificates, discounts, reductions in shipping cost, free trial memberships, and other special offers provided from various third-party business partners. The promotional incentives 193 may include offers from a wide variety of interests and third-party business partners in order to appeal to a wide variety of interests of the user-authors. Thus, the exemplary system 100 may be used as an incentive procedure to generate greater user participation over the network 101. Greater user participation may encourage the user-author 170 to provide various user-authored content 175, as well as encourage additional user-authors to join the system 100 and contribute further user-authored content 175.

According to exemplary embodiments, user-author 170 may receive points for creating user-authored content 175 that is approved by a network editor. These points may be exchanged for the above-mentioned exemplary promotional incentives 193 for goods and/or services provided the third-party business partner 190. For example, the application server 105 may designate specific user-authors, such as user-author 170, as the recipient of one or more promotional incentives 193, such as free shipping on any online purchase, provided by the third-party business partner 190, wherein third-party business partner 190 is an online retailer. Therefore, the system 100 may function as a lead-generator for the exemplary third-party business partner 190, wherein the system 100 may promote usage of the goods and/or services provided by the third-party business partner 190 as well as potentially drawing increased online traffic to websites of the third-party business partner 190. In addition, the system 100 may also aggregate valuable promotional incentives 193 from the third-party business partner 190 for the user-author 170, wherein the user-author 170 may be otherwise unable to have access to such promotional incentives 193 without generating articles of user-authored content 175 for the system 100.

It is important to note that while FIG. 1 illustrates each of the user-author 170, the third-party business partner 190, and the content viewer 180 as respective single entities, one of skill in the art would understand that each of these components may include multiple entities. Thus, for example, several different content viewers may access the same user-authored content 175. Furthermore, it should be noted that a single entity may act as multiple components. Accordingly, the user-author 170 of content 175 may act as a content viewer for a different user-authored content within the content database 107.

The monitoring server 113 may be in communication with the CPU 115 in order to monitor the activities of the content viewer 180 over the network 101. According to exemplary embodiments of the present invention, the monitoring server 113 may run one or more monitoring algorithms that monitor the number of times the user-authored content 175 is viewed and/or downloaded by the content viewer 180. A predetermined formula may be utilized to determine an amount of revenue generated by the system 100 that will be allocated to any of the user-authors. The use of the monitoring algorithms and predetermined formulas will be described in greater detail below.

According to an exemplary embodiment of the present invention, the system 100 may further include an indexing server 117. The indexing server 117 may index various articles of user-authored content 175 according to predetermined content properties or attributes of each of the articles of content. Once indexed, the user-content 175 may be searchable by the content viewer. For example, the predetermined content attributes of the article may include subject matter, category, genre, field of study, and other characteristics. In order to allow the content viewer 180 to search for specific articles of user-content 175 over the network, the indexed content attributes may be included as search criteria within a network search engine. Those skilled in the art would understand the functionalities of the network search engine.

In addition to the user-authored content 175, the advertisements 191 of the third-party business partner 190 may also be indexed by the indexing server 117 based upon predetermined advertising attributes, such as, for example, a type of business. As discussed above, the application server 105 may run placement algorithms in order to embed, or place, advertisements 191 of certain goods and/or services within, or adjacent to, the articles of user-authored content 175. Similar to the indexing of the user-authored content 175, the indexing server 117 may index the advertisements 191 according to predetermined properties of the advertisements 191 and/or the supplying third-party business partner 190. According to exemplary embodiments of the present invention, at least one of the properties of the user-authored content 175 may be related to at least one of the properties of the advertisements 191, wherein the term related may be defined as sharing at least one common property between the content and one of the advertisement 191.

The application server 105 may determine whether one of the indexed content attributes is related to any one of the indexed advertising attributes. For example, a content attribute may be the subject matter of the user-authored content 175, while an advertising attribute may be the business field of the advertising third-party business partner 190. Under this example, the user-authored content 175 may be a medical article pertaining to new cancer treatments and an advertising third-party business partner may be a pharmaceutical company or a hospital. Accordingly, an advertisement 191 may be embedded within the user-authored content 175, wherein the advertisement 191 relates to hospitals specializing in cancer treatment. Alternatively, the advertisement may relate to a pharmaceutical company and include information about cancer treatment drugs provided by the company.

Optionally, the system 100 may utilize one or more system administrators (e.g., staff members) that may also determine whether one of the indexed content attributes is related to any one of the indexed adverting attributes. The system administrators may perform functions similar to the various algorithms performed by the application server 105. In addition, the system administrators may include network moderators, staff writers and content editors. The network moderators and content editors may review and alter the user-authored content 175 and may administer the distribution of the revenue and/or promotional incentives 193. The staff writers may contribute additional content to the system 100. Thus, the system 100 may include a mixture of user-authored content 175 and staff-authored content. The staff writers may be salaried individuals that may be compensated directly by the system administrators for the generation of staff-authored content. The compensation received by the staff writers may be made separate from the revenue shared by the user-authors of the system 100.

According to further exemplary embodiments of the present invention, the system 100 may also allow for revenue sharing between multiple user-authors, wherein income derived from multiple third-party business partners may be proportioned and distributed as compensation to the user-authors. In order to calculate a revenue sharing proportion, the system 100 may utilize a predetermined revenue formula to determine how revenue derived from the third-party business partner 190 will be allocated to any particular user-author for any of their content that is made available to the system 100. The revenue formula for compensating the user-author 170 may be based on numerous factors. For instance, the user-author 170 may receive compensation based on factors such as: the number of times a particular article of user-authored content 175 is viewed and/or downloaded by the exemplary content viewer 180; or whether the particular article of user-authored content 175 has an embedded, or adjacent, advertisement from a sponsoring third-party business partner and the content 175 is viewed by the content viewer 180; or whether the content viewer 180 clicks through to the advertisement (e.g., banner/sidebar ad, hyperlink, etc.) that is associated with the user-authored content 175. Furthermore, the user-author 170 may also receive compensation based on the number of articles of user-authored content 175 generated by the user-author 170.

Compensation may further be based on a particular attribute (e.g., topic, genre, field of study, etc.) of the user-authored content 175. Optionally, compensation may be based on the number of hyperlinks within the system 100 that are made to the user-author content 175 by other user-authors, by the user-author 170, and/or by the content viewer 180. The exemplary system 100 may used any combinations of these factors, or additional factors, for determining compensation received by the user-author 170. It is important to note that the revenue need not be shared evenly amongst each of the user-authors within the network 101. In addition, the multiple revenue formulas may be applied to varying types of content. For example, an article of user-authored content directed to the subject matter of health care may determine revenue through a different formula than a formula used for user-authored content directed to fine art. Any formula that shares revenue generated by the system 100 containing articles of user-authored content is contemplated by the exemplary embodiments of the present invention. In addition to each compensation option, the user-author 170 may optionally exchange digital copyrights in perpetuity for the user-authored content 175.

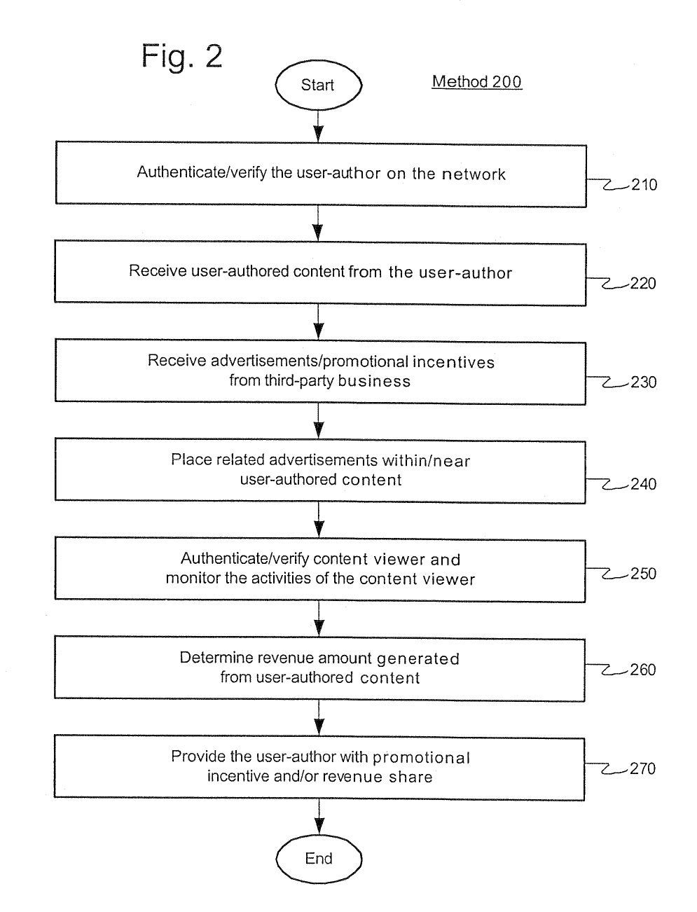

FIG. 2 shows an exemplary method 200 for publishing and distributing content over a system 100 for the sharing of revenue derived from the content according to the present invention. The exemplary method 200 will be described with reference to the exemplary system 100 of FIG. 1. According to the present invention, the method 200 may provide incentive to the user-author 170 to generate user-authored content 175. As described above, the present invention may operate with all currently existing and future developed network architectures and/or network architecture combinations. In addition, the content available via the network 101 may be user-authored content and/or staff-authored content. The exemplary embodiments of the present invention provides for the use of revenue algorithms to accurately calculate the proportion of the revenue that the user-author 170 may share with operators of the present invention.

In step 210, an exemplary system 100 may authenticate and/or verify the user-author 170 over the network 101. If the user-author 170 is a new user-author to the network 101, the system 100 may require the user-author 170 to register as a member prior to submitting the user-authored content 175. The registration process may require the user-author 170 to submit identifying information. If the user-author 170 is an existing member, the system 100 may simply verify the identity of the user-author 170 using information received during an earlier registration. The verification process may include, for example, logging on the system 100 via a user name and password.

In step 220, the exemplary system 100 may receive the user-authored content 175 from the user-author 170. The exemplary system 100 may store the user-authored content in a content database 107. Optionally, upon receiving the user-authored content 175, the indexing server 117 may determine content attributes within the user-authored content 175 and index the content attributes within the content database 107.

In step 230, the exemplary system 100 may receive advertisements 191 and/or promotional incentives 193 from at least one third-party business partner 190. The exemplary system 100 may store the advertisements 191 in an advertisement database 111, and likewise, store the promotional incentives 193 in a promotion database 113. Optionally, upon receiving the advertisements 191, the indexing server 117 may determine advertising attributes within the advertisements 191 and index the advertising attributes within the advertisement database 111. This index may also be correlated to the index of the user authored content so that advertising may be targeted to relevant user authored content. This indexing of advertising may be based on attributes that the system 100 (or system administrators) select from the advertising, e.g., product/service offered, type of company, etc. In a further embodiment, the third party business 190 may be able to select the type of user authored content with which its advertising will be correlated. This correlation may be related or unrelated to the user authored content. For example, if the particular system 100 has user authored content on a variety of topics (e.g., sports, news and opinion, movies, etc.), a third party business 190 that s a car manufacturer may request that their ads be correlated to the sports content. Similarly, the third party business 190 may request that their ads be correlated to a particular user author. The owner of the system 100 may use such requests as a factor in setting advertising rates (e.g., the most requested type of correlation by third party businesses may have a higher rate). Similarly, when the owner of the system 100 compensates user authors 170 for contributions of user authored content 175, the compensation may be biased toward those user authors 170 that contribute to topics that have higher advertising rates.

In step 240, the application server 105 may query the advertisement database in order to determine whether any advertising attributes are related to any of the content attributes. Also during step 240, the application server 105 may either place the one or more advertisements adjacent to the user-authored content 175 or may embed the one or more advertisements within the content 175. According to the results of one exemplary query, a single advertisement may be embedded within the user-authored content 175, or multiple advertisements may be embedded within the user-authored content 175. Thus, the user-authored content 175 may have advertisements 191 (e.g., banner/sidebar ads, hyperlinks, etc.) to related companies, products, services and/or other additional user-authored content within the network 101. Finally, during step 240, the application server 105 may place at least one of the third-party business partner advertisements 191 and publish the user-authored content 175 with the advertisement(s) 191. Those skilled in the art will understand that the act of placing an advertisement 191 within a particular piece of user authored content 175 may be a dynamic process. For example, each time a content viewer 180 selects the particular piece of user authored content 175, the system 100 may place a different advertisement 191 with the user authored content 175.

In step 250, the exemplary system may authenticate and/or verify the content viewer 180 and may monitor the viewing of the user-authored content 175 by the content viewer 180. Similar to the authentication and verification processes used on the user-author 170, the system 100 may require new content viewers to register and may verify any content viewers that are existing members. As described above, the registration of the content viewer 180 may be limited to members of a particular organization or professional affiliation (e.g., medical doctors, attorneys, etc.). Alternatively, the system 100 may operate on a fee or subscription basis, wherein the content viewer 180 may pay a structured fee (e.g., monthly fee, pay per download, etc.) for access to the user-authored content 175. Thus, access to the system 100 may be granted to the content viewers 180 by means of fee, wherein the fee may generate additional revenue to the system 100. The user-author 170 may be further compensated with a portion of the revenue derived from subscription fees. However, the system 100 may also be freely available to content viewers 180, thereby eliminating the need for verification. It is also noted that there are other types of revenue models that the owner of the system 100 may implement to make the system 100 a commercially viable operation in addition to advertising revenue, subscription fees and download fees. The exemplary embodiments of the present invention may be implemented on any system without reference to the revenue model used by the system owner. The exemplary embodiments of the present invent are directed to manners of compensating user authors for contributed content. The manner in which the owner generates revenue to compensate the user authors is not relevant.

Once the content viewer 180 has been registered and/or verified and/or simply accesses the system 100, the application server 105 of the system 100 may run one or more monitoring algorithms that monitor activity by the content viewer 180. The monitored activity may include the number of times the content viewer 180 views and/or downloads the user-authored content 175. The monitored activity may further include whether the content viewer 180 clicks through an embedded or adjacent advertisement 191 of the third-party business partner 190, and whether the content viewer 180 subsequently purchases a good or service offered by the advertising third-party business partner 190. Thus, the monitoring algorithm may determine each service purchase, good purchase, and any other actions that the content viewer 180 may take that originates as result of the content viewer 180 viewing the user-authored content 175.

In step 260, the application server 105 of the exemplary system 101 may determine a revenue amount received from the viewing of the user-authored content 175 and may determine a portion of the revenue amount to share with the user-author 170. The application server 105 may utilize one or more revenue algorithms having predetermined formulas for determining the portion of the revenue amount to share. The revenue algorithms may incorporate information derived from the monitoring algorithms in order to determine the portions of the revenue amount to share with the user-author 170. In addition to incorporating the monitored activities (e.g., viewings, click-throughs, purchases, etc.) made by the content viewer 180, the revenue algorithms may also include other factors based on the user-author 170. The other factors may include the number of total articles by the user-author that are approved and published on the system 100, one or more particular content attributes of the user-authored content 175, the number of hyperlinks made to the user-authored content 175 by other user-authors, content viewers, and/or the user-author 175, and any combination of factors. Additionally, subscription fees and/or revenue derived directly from downloading the user-authored content 175 may be a factor for determining a revenue amount to share with user-author 170.

According to exemplary embodiments of the present invention, the user-author 170 may be provided with a predetermined dollar amount for every viewing of one or more advertisements embedded in, or placed adjacent to, the user-authored content 175. For example, the user-author may receive a fixed fee amount or percentage of a sales price for a purchased made by the content viewer 180. Furthermore, the revenue generated from the system 100 may be shared with the user-author 170 based on an aggregate number of individual advertisement viewings by a plurality of content viewers, wherein the aggregate number relates to a total number of viewings between multiple articles of user-authored content 175 created by the user-author 170.

According to a further embodiment of the present invention, revenue generated from the system 100 may be shared with a user-author 170 based on the content environment accompanying and/or surrounding the user-authored content 175. The term content environment may refer to all content served and/or presented with the user-authored content 175 that is not the user-authored content 175 queried by the content viewer 180. For example, each time a content viewer 180 views user-authored content 175, the system 100 may display and/or present additional content and/or links to additional content while presenting the user-authored content 175. The additional content and/or links to additional content may also include additional user-authored content. The content environment accompanying the user-authored content 175 may be presented, for example, by an advertising server. The application server 105 may log the content environment accompanying and/or surrounding each article of user-authored content. Thus, any revenue generated by the content environment accompanying and/or surrounding the user-authored content 175 may be shared with the user-author 170 based on the logged content environment. The exact revenue algorithm used for determining the revenue share for the user-author 170 may depend in part on how each of the advertisements 191 is negotiated with the advertising third-party business partner.

In step 270, the exemplary system 100 may provide the user-author 170 with the portion of the revenue amount to share and/or a promotional incentive 193 provided by the third-party business partner 190. As described above, the revenue amount may be percentage of a purchase made by a content viewer 180 over a product or service offered by advertising third-party business partner 190. Alternatively, the user-author 170 may receive promotional points as incentive for generating user-authored content 175. According to this exemplary embodiment of the present invention, the points may be exchanged by the user-author 170 for goods and services of value as provided by the third-party business partner 190. For example, a user-author 170 may receive a point for every article of user-authored content 175 that is submitted to the network and approved by a network administrator. Upon accumulating a certain number of points, the user-author redeem promotional incentives 193 such as gift certificates and promotional codes from any of the third-party business partners that provide the incentives. Accordingly, the user-author 170 may receive more valuable promotional incentives 193 by accumulating and redeeming additional points.

It should also be noted that the user author 170 may have the option of selecting the type of incentive that the user author desires for contributing content. That is, the system 100 may be able to individualize the incentive for each particular user author 170. For example, a first user author 170 may desire to strictly receive cash payments for each contribution of content, while a second user author 170 may desire to receive promotional offers from a predetermined list of third party businesses 190. The system 100 may keep track of these requests by the user authors 170 and reward each user author 170 accordingly.

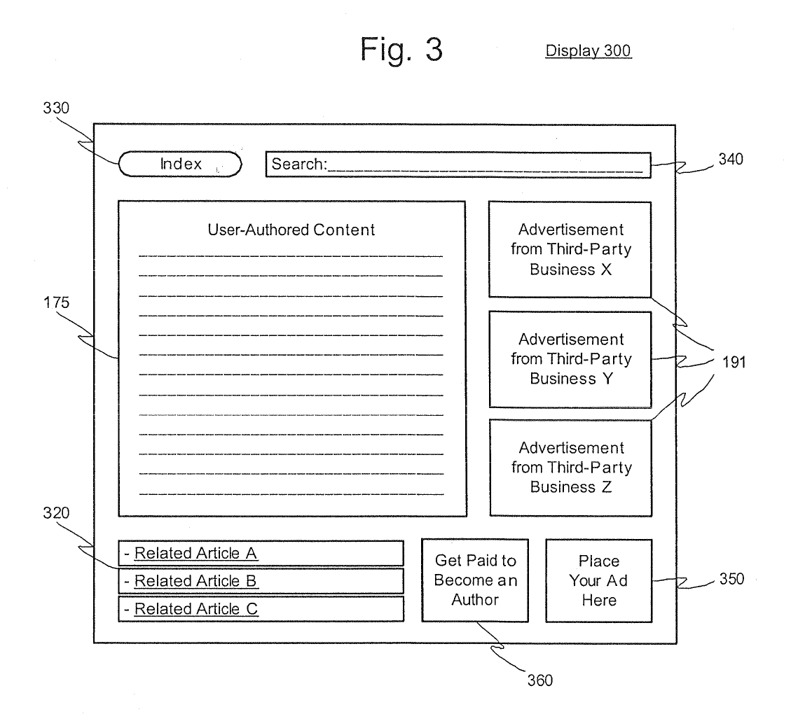

FIG. 3 shows an exemplary display 300 of the published article of user-authored content 175 as presented to the content viewer 180 according to the present invention. The exemplary display 300 will be described with reference to the exemplary system 100 of FIG. 1. According to exemplary embodiments of the present invention, the display 300 may be a website display presented to the content viewer 180 over the network 101. The display 300 may include the user-authored content 175 and the plurality of advertisements 191. As described above, one or more advertisements 191 may be embedded within, or placed adjacent to the display of the user-authored content 175. The content viewer 180 may click on any of the advertisements 191 in order to be directed to, for example, a website of the advertising third-party business partner 190.

In addition, the display 300 may also include content hyperlinks 320, a content index 330, and a search bar 340. Each one of these display components may be activated by the content viewer 180. The content hyperlinks 320 may direct the content viewer 180 to various related articles of user-authored content. The articles may be considered to be related if, for example, the articles are created by the same user-author 170, or the articles pertain to the same subject matter. By activating the content index 330, the content viewer 180 may be directed to a listing of the various content attributes and any of the articles of user-authored content that relate to each of the content attributes. Thus, the content index 330 may provide the content viewer 180 with access to each of the content attributes available over the network 101. The search bar 340 may receive search criteria from the content viewer 180 and activate a search engine. The search engine may search the information stored in the content database 107 and provide the content viewer 180 with a list of references to user-generated content that meet the search criteria.

Finally, the display 300 may also include an invitation to become a third-party business partner 350 and an invitation to become a user-author 360. An exemplary embodiment of the invitation to be a third-party business partner 350 may be a command button or hyperlink displaying the phrase “Place Ad Here.” By clicking on the command button or hyperlink 350, the viewer may be notified of the benefits presented to third-party business partners for placing an advertisement 191 or providing a promotional incentive 193. Thus, this information may encourage a relationship between a third-party business 190 and the system 100. An exemplary embodiment of the invitation to be a user-author 350 may be a command button or hyperlink displaying the phrase “Get Paid to Become an Author.” By clicking on the command button or hyperlink 360, the viewer may be notified of the benefits presented to the user-authors of the system 100. Thus, this information may encourage the content viewer 180 to become a user-author 170.

According to one application consistent with exemplary embodiments of the present invention, the system 100 may be developed around instructional information, i.e., information related to instructing laypersons about how various technologies operate and/or “walk-throughs” for operating a program or device. The user-authors 170 may be members of the system 100 and may publish user-author content 175 such as articles to the network based on the personal expertise or personal interests of the user-author 170. The articles are published and indexed based on user provided information and/or indexing algorithms stored on the network.

According to another application consistent with exemplary embodiments of the present invention, the system 100 may be developed around educational materials, i.e., materials related to teaching students. The user-authors 170 may be members of the system 100 and may publish user-author content 175 such as educational materials. The user-authored content 175 may be indexed based on user provided information and/or indexing algorithms stored on the network. For example, materials related to the teaching of mathematics would be indexed as math with a sub-index based on the particular category within mathematics, for example, calculus/partial derivatives.

According to further application consistent with exemplary embodiments of the present invention, the system 100 may be developed around maternity information, i.e., educational and personal accounts relating to pregnancy, baby and childbirth matters. The user-authors 170 may be members of the system 100 and may publish user-author content 175 to new or expecting mothers. The user-authored content 175 may be indexed based on user provided information and/or indexing algorithms stored on the network.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

1-20. (canceled)

21. A computer-assisted method of distributing revenue among user-authors, the computer comprising a processor, the method comprising:
receiving user-authored content from one or more user-authors over a network;
receiving at least one advertisement from one or more third-parties over the network;
placing the at least one advertisement within the user-authored content;
indexing, via the processor, the at least one advertisement according to advertising attributes;
monitoring activities of one or more content viewers over the network; and
determining a compensation for at least one of the user-authors, wherein the compensation is based on the monitored activities of the one or more content viewers; and
wherein the advertising attributes comprise a business field.

22. The method according to claim 21, further comprising:
indexing the user-authored content according to content attributes;
comparing the content attributes with the advertising attributes; and
placing at least one advertisement within the user-authored content, wherein the advertising attributes relate to the content attributes.

23. The method according to claim 21, wherein the compensation is determined based on one of (i) a number of times the user-authored content is viewed, (ii) a number of times the user authored content is downloaded, (iii) a number of time the advertisement within the user-authored content are viewed, (iv) a number of pieces of user-authored content received from the user-author, (v) a content attribute of the user-authored content, and (vi) a number of references made to the user-authored content within the network.

24. The method according to claim 21, further comprising: authenticating the user-author within the network.

25. The method according to claim 21, further comprising: authenticating the content viewer within the network.

26. A system, comprising:
a first receiving means receiving user-authored content from one or more user-authors over a network;
a second receiving means receiving at least one advertisement from one or more third-parties over the network;
an advertisement indexing means indexing the at least one advertisement according to advertising attributes;
a placement means placing the at least one advertisement within the user-authored content;
a monitoring means monitoring activities of one or more content viewers over the network; and
a determining means determining a compensation for at least one of the user-authors, wherein the compensation is based on the monitored activities of the one or more content viewers; and
wherein the advertising attributes comprise a business field.

27. The system according to claim 26, further comprising:
a content indexing means indexing the user-authored content according to content attributes;
a comparison means comparing the content attributes with the advertising attributes; and
a further placement means placing at least one advertisement within the user-authored content, wherein the advertising attributes relate to the content attributes.

28. The system according to claim 26, wherein the compensation is determined based on one of: a number of times the user-authored content is viewed and/or downloaded, a number of advertisement with the user-authored content that are viewed by the content viewer; a number of user-authored content received from the user-author; a content attribute of the user-authored content; a number of references made to the user-authored content within the network; and combinations thereof.

29. The system according to claim 26, further comprising: a user authenticating means authenticating the user-author within the network.

30. The system according to claim 26, further comprising: a viewer authenticating means authenticating the content viewer within the network.

31. A system, comprising: an application server for receiving user-authored content from one or more user-authors, and for receiving at least one advertisement from one or more third-parties, wherein the application server places the at least one advertisement within the user-authored content; a content database for storing the user-authored content, wherein the content database is accessible to a viewer over a network; a advertisement database for storing the advertisement; a first algorithm for measuring at least one of the number of times the user-authored content is accessed by the viewer and the number of links to the user-authored content; and a second algorithm for calculating the amount of revenue generated by the network to share with the user-author.

32. The system according to claim 31, further comprising: an monitoring server for monitoring activities of the viewer over the network.

33. The system according to claim 31, further comprising: an indexing server for indexing the user-authored content according to content attributes, and for indexing the advertisement according to advertising attributes, wherein the advertisement is placed within the user-authored content when the advertising attributes relate to the content attributes.

34. A computer-assisted method of distributing revenue among user-authors, the computer comprising a processor, the method comprising:
receiving user-authored content from one or more user-authors;
receiving at least one advertisement from one or more third-parties;
indexing, via the processor, the at least one advertisement according to advertising attributes;
associating the at least one advertisement with the user-authored content;
determining a compensation for at least one of the user-authors, wherein the compensation is based on at least one of the number of advertisements associated with the user authored content and a number of associations made with the user-authored content by third parties; and
wherein the advertising attributes comprise a business field.

35. The method according to claim 34, further comprising, determining the compensation for at least one of the user authors based further on monitored activities of one or more content viewers over a network.

36. The method of claim 35, wherein the monitored activities include one of (i) a number of times the user-authored content is viewed, (ii) a number of times the user authored content is downloaded and, (iii) a number of time the advertisement within the user-authored content are viewed.

37. The method of claim 34, wherein the user authored content is one of a written commentary, an editorial, a musical composition, a novel, an essay, a product review, a help guide, an educational article, a medical article, a fine art composition, a multimedia work, an audiovisual work and a movie.

38. The method of claim 34, wherein the associating includes embedding the at least one advertisement within the user authored content.

39. The method of claim 34, wherein the compensation is further based on a type of the user authored content.

40. The method of claim 34, further comprising: collecting revenue from viewers of the user authored content.
